(19) United States
(12) Patent Application Publication
(10) Pub. No.: US 2008/0106497 A1
(43) Pub. Date: May 8, 2008

(54) PLASMA DISPLAY PANEL

(75) Inventors: Woong Kee MIN, Gangjin-gun (KR); Jung Won Kang, Ichon-dong (KR); Jae Bum Park, Seongnam-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/957,890

(22) Filed: Dec. 17, 2007

Related U.S. Application Data
(62) Division of application No. 10/933,464, filed on Sep. 3, 2004.

(30) Foreign Application Priority Data
Nov. 5, 2003 (KR) 10-2003-0077936
May 7, 2004 (KR) 10-2004-0032391
Jun. 10, 2004 (KR) 10-2004-0042467

(51) Int. Cl. G09G 3/28

(52) U.S. Cl. 345/60

(57) ABSTRACT

The present invention relates to a plasma display panel, and more particularly, to an electrode structure of a plasma display panel capable of improving brightness and efficiency. According to the present invention, in the plasma display, assuming that a distance from the center of a discharge region between a pair of transparent electrodes to the center of metal electrodes is “d” and a distance between both ends of the pair of the transparent electrodes is “h”, a location on the transparent electrodes of metal electrodes satisfies d<h/4. Therefore, brightness and efficiency can be increased without increasing the Xe content. Furthermore, it is possible to reduce power consumption since a discharge start voltage and a discharge sustain voltage are lowered. Discharge stability can be improved since a discharge delay time is shortened.

### CROSS-REFERENCE TO RELATED APPLICATIONS

This application is a Divisional Application of prior U.S. patent application Ser. No. 10/933,464 filed Sep. 3, 2004, which claims priority under 35 U.S.C. §119 to Korean Application Nos. 10-2003-0077936 filed on Nov. 5, 2003, 10-2004-0032391 filed on May 7, 2004 and 10-2004-0042467 filed on Jun. 10, 2004, whose entire disclosures are hereby incorporated by reference.

### BACKGROUND OF THE INVENTION

1. Field of the Invention

The present invention relates to a plasma display panel, and more particularly, to an electrode structure of a plasma display panel capable of improving brightness and efficiency.

2. Description of the Background Art

Various flat panel display devices, which can reduce the weight and volume as shortcomings of the cathode ray tube, have recently been developed. These flat panel display devices include a liquid crystal display (LCD), a field emission display (FED), a plasma display panel (hereinafter, referred to as “PDP”), an electro-luminescence (EL) display device and so on.

Of them, the PDP is a display device using a gas discharge and has an advantage in that it can be easily fabricated as a large-scaled panel. FIG. 1 is a perspective view illustrating the electrode structure of a conventional plasma display panel. A representative PDP is a three-electrode AC surface discharge type PDP having three electrodes and driven by an AC voltage, as shown in FIG. 3.

Referring to FIG. 1, the conventional PDP cell includes a pair of sustain electrodes 14 and 16 sequentially formed on an upper substrate 10, an upper plate having an upper dielectric layer 18 and a protection film 20, and a lower plate having an address electrode 22, a lower dielectric layer 24, barrier ribs 26 and a phosphor layer 28 all of which are sequentially formed on a lower substrate 12. The upper substrate 10 and the lower substrate 12 are spaced apart from each other in parallel by means of the barrier ribs 26.

The upper dielectric layer 18 and the lower dielectric layer 24 are accumulated with electric charges. The protection film 20 serves to not only prevent the upper dielectric layer 18 from being damaged due to sputtering, thus extending the life span of the PDP, but also increase emission efficiency of secondary electrons. Magnesium oxide (MgO) is usually used as the protection film 20.

The address electrode 22 is formed so that it intersects the pair of the sustain electrodes 14 and 16. The address electrode 22 is supplied with a data signal for selecting cells to be displayed.

The barrier ribs 26 are formed in parallel to the address electrode 22 and serve to prevent ultraviolet rays generated by a discharge from leaking toward neighboring cells. In the above, the barrier ribs 26 may exist at the boundary line of sub-pixels or not.

The phosphor layer 28 is coated on the lower dielectric layer 24 and the barrier ribs 26 and emits one of visible rays, i.e., red, green and blue. In addition, an inert gas such as He+Xe, Ne+Xe or He+Xe+Ne for a gas discharge is injected into discharge spaces formed between the upper substrate 10 and the lower substrate 12 and between the upper substrate 10 and the barrier ribs 26.

One pair of the sustain electrodes 14 and 16 is composed of a scan electrode 14 and sustain electrodes 16. The scan electrode 14 is mainly supplied with a scan signal for a panel scanning and a sustain signal for a discharge sustain. The sustain electrode 16 is mainly supplied with the sustain signal.

The sustain electrode 14 includes a transparent electrode 14A that has a relatively wide width and a stripe shape and that is formed using a transparent electrode material (ITO) in order to transmit a visible ray, and a metal electrode 14B that is relatively narrow in width and formed using a metal in order to compensate for a resistant component of the transparent electrode 14A. Further, the sustain electrode 16 includes a transparent electrode 16A that has a relatively wide width and a stripe shape and that is formed using a transparent electrode material (ITO) in order to transmit a visible ray, and a metal electrode 16B that is relatively narrow in width and formed using a metal in order to compensate for a resistant component of the transparent electrode 16A. In the above, the transparent electrodes 14A and 16A of each of the pair of the sustain electrodes 14 and 16 are opposite to each other with a predetermined gap intervened between them.

FIG. 2 is a cross-sectional view showing the pair of the sustain electrodes shown in FIG. 1. Referring to FIG. 2, the metal electrodes 14B and 16B of the pair of the sustain electrodes 14 and 16 are formed at the edges on one side of the transparent electrodes 14A and 16A so that they are located at the outer block of a discharge cell. That is, the metal electrodes 14B and 16B are formed at the edges of the outer blocks of the transparent electrodes 14A and 16A, i.e., regions that are far from a space where a discharge occurs.

A cell of a PDP having this structure is selected by an opposite discharge between the address electrode 22 and the scan electrode 14 and keeps a discharge by a surface discharge between the pair of the sustain electrodes 14 and 16. In the cell of the PDP, a phosphor material of the phosphor layer 28 is emitted by an ultraviolet ray that is generated at the time of a sustain discharge, so that a visible ray is emitted outside the cell. As a result, the PDP having cells displays an image. In this case, the PDP implements the gray scale necessary to display an image by controlling a discharge sustain period of the cell, i.e., the number of the sustain discharge depending on video data.

In such a conventional PDP, a vacuum ultraviolet ray, which is generated when xenon (Xe) of the inert gases injected into the discharge spaces is changed from the exciting state to the ground state by means of a gas discharge, excites the phosphor material of the phosphor layer 28. Therefore, as the amount of xenon (Xe) contained in the inert gas increases, the amount of the vacuum ultraviolet ray generated at the time of the gas discharge also increases in the discharge spaces. It is thus possible to increase efficiency of the PDP.

However, an increase in the Xe content results in a side effect that a discharge start voltage and a discharge sustain voltage between front substrate electrodes are increased. In addition, as the Xe content increases, the discharge delay time increases. This results in increased instability of a discharge.

Furthermore, in the conventional PDP, since the metal electrodes 14B and 16B are formed at the edges on the outer blocks of the transparent electrodes 14A and 16A, a distance between the metal electrodes 14B and 16B becomes more distant. Therefore, it has a problem that the discharge start voltage and the discharge sustain voltage become high.

### SUMMARY OF THE INVENTION

Accordingly, an object of the present invention is to solve at least the problems and disadvantages of the background art.

An object of the present invention to provide a plasma display panel capable of increasing brightness and efficiency without increasing the Xe content.

Another object of the present invention is to provide a plasma display panel capable of reducing power consumption by lowering a discharge start voltage and a discharge sustain voltage of the PDP.

Still another object of the present invention is to provide a plasma display panel capable of enhancing discharge stability by shortening a discharge delay time of the PDP.

In order to achieve the above objects, according to a first embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein assuming that a distance from the center of a discharge region between the pair of the transparent electrodes to the center of the metal electrodes is “d” and a distance between both ends of the pair of the transparent electrodes is “h”, a location on the transparent electrodes of the metal electrodes satisfies d<h/4.

According to a second embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the metal electrodes are formed at locations inclined toward a side where the pair of the transparent electrodes are opposite to each other, and the plasma display panel further comprises auxiliary metal electrodes formed between the opposite end of the side where the pair of the transparent electrodes are opposite to each other and the metal electrodes.

According to a third embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the metal electrodes are formed at locations inclined toward a side where the pair of the transparent electrodes are opposite to each other, and the plasma display panel further comprises projection electrodes projected from the metal electrodes.

According to a fourth embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the transparent electrodes are included in the discharge cell, and assuming that a distance from the center of a discharge region between the pair of the transparent electrodes to the center of the metal electrodes is “d” and a longitudinal width of the discharge cell is “L”, a location on the transparent electrodes of the metal electrodes satisfies d<L/4.

According to a fifth embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the transparent electrodes are formed by patterning, and assuming that a distance from the center of a discharge region between the pair of the transparent electrodes to the center of the metal electrodes is “d” and a longitudinal width of the discharge cell is “L”, a location on the transparent electrodes of the metal electrodes satisfies d<L/4.

According to a plasma display panel of the present invention, brightness and efficiency can be increased without increasing the Xe content. Furthermore, it is possible to reduce power consumption since a discharge start voltage and a discharge sustain voltage are reduced. Discharge stability can be improved since a discharge delay time is shortened.

### BRIEF DESCRIPTION OF THE DRAWINGS

The invention will be described in detail with reference to the following drawings in which like numerals refer to like elements.

FIG. 1 is a perspective view illustrating the electrode structure of a conventional plasma display panel.

FIG. 2 is a cross-sectional view showing the pair of the sustain electrodes shown in FIG. 1.

FIG. 3 is a plan view showing a front substrate electrode structure of a surface discharge type PDP for explaining definition of parameters to be used in the present invention.

FIG. 4 is a plan view showing a front substrate electrode structure of a surface discharge type plasma display panel according to a first embodiment of the present invention.

FIG. 5 is a graph showing the relationship between an application voltage and efficiency in a conventional PDP and the PDP according to the first embodiment of the present invention.

FIG. 6 is a graph that efficiency is compared when the locations of the metal electrode are d<h/8 and h/8≦d≦h/4.

FIG. 7 is a table showing a comparison result of a discharge delay time when the location of the metal electrode is (A) and (B).

FIG. 8 is a perspective view illustrating the electrode structure of a plasma display panel according to a second embodiment of the present invention.

FIG. 9 is a plan view showing a pair of the sustain electrodes shown in FIG. 8.

FIG. 10 is a cross-sectional view of the electrode taken along lines A-A′ in FIG. 9.

FIG. 11 is a graph showing the relationship between brightness and a voltage in the second embodiment of the present invention and a prior art.

FIG. 12 is a graph showing the relationship between efficiency and a discharge voltage in the second embodiment of the present invention and a prior art.

FIG. 13 is a plan view showing a pair of sustain electrodes of a plasma display panel according to a modification example of the second embodiment of the present invention.

FIG. 14 is a plan view showing a pair of sustain electrodes of a plasma display panel according to another modification example of the second embodiment of the present invention.

FIG. 15 is a plan view showing a pair of sustain electrodes of a plasma display panel according to a third embodiment of the present invention.

FIG. 16 is a graph showing the relationship between brightness and a voltage in the third embodiment of the present invention and a prior art.

FIG. 17 is a graph showing the relationship between efficiency and a voltage in the third embodiment of the present invention and a prior art.

FIG. 18 is a plan view showing a pair of sustain electrodes of a plasma display panel according to a modification example of the third embodiment of the present invention.

FIG. 19 is a plan view showing a pair of sustain electrodes of a plasma display panel according to another modification example of the third embodiment of the present invention.

FIG. 20 is a plan view showing a pair of sustain electrodes of a plasma display panel according to still another modification example of the third embodiment of the present invention.

FIG. 21 is a plan view showing a front substrate electrode structure of a PDP according to a fourth embodiment of the present invention.

FIG. 22 shows a comparison result of the electron density in the front substrate electrode structure of the PDP according to the fourth embodiment of the present invention and a prior art.

FIG. 23 is a graph showing the relationship between luminous efficiency and a sustain voltage in the electrode structure of the PDP according to the fourth embodiment of the present invention and the electrode structure of a conventional PDP.

FIG. 24 is a plan view showing a front substrate electrode structure of a PDP according to a modification example of the fourth embodiment of the present invention.

FIG. 25 is a plan view showing a front substrate electrode structure of a plasma display panel according to a fifth embodiment of the present invention.

FIGS. 26 an 27 are plan views showing a front substrate electrode structure of a plasma display panel according to a modification example of the fifth embodiment of the present invention.

FIG. 28 shows a comparison result of the electron density in the electrode structure according to the fifth embodiment of the present invention and a typical electrode structure.

FIG. 29 is a graph showing a comparison result of luminous efficiency E1 of a plasma display panel having the electrode structure according to the fifth embodiment of the present invention and luminous efficiency E2 of a plasma display panel having a typical electrode structure when a sustain voltage is varied.

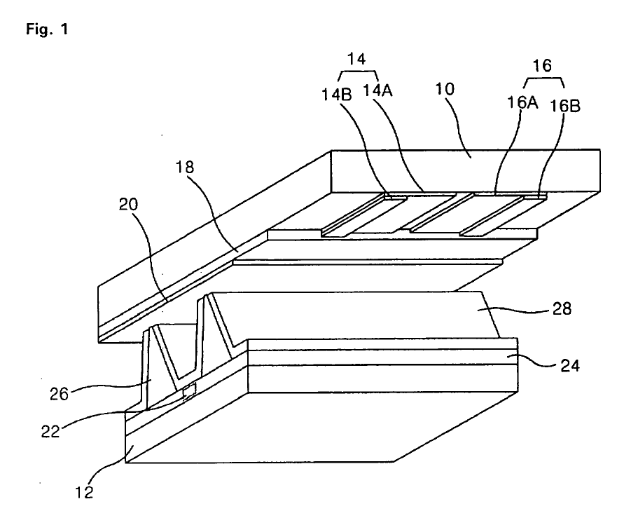

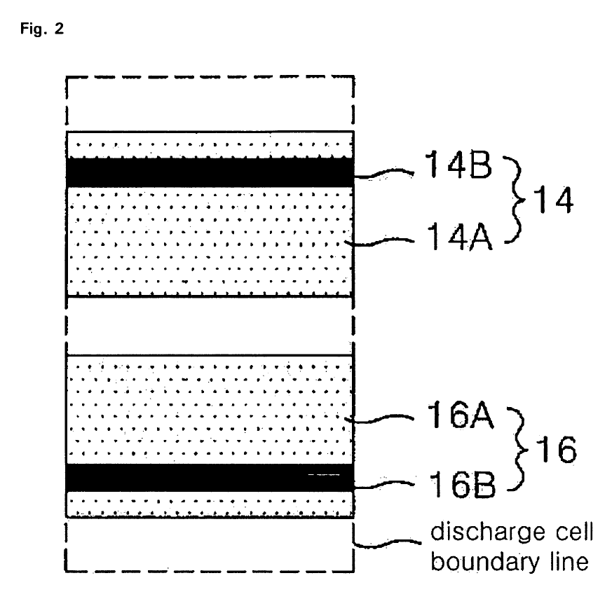

### DETAILED DESCRIPTION OF PREFERRED EMBODIMENTS

Preferred embodiments of the present invention will be described in a more detailed manner with reference to the drawings.

### First Embodiment

According to a first embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein assuming that a distance from the center of a discharge region between the pair of the transparent electrodes to the center of the metal electrodes is “d” and a distance between both ends of the pair of the transparent electrodes is “h”, a location on the transparent electrodes of the metal electrodes satisfies d<h/4.

Furthermore, the distance d from the center of the discharge region between the pair of the transparent electrodes to the center of the metal electrodes further satisfies h/8<d.

The first embodiment of the present invention will now be described in detail with reference to the accompanying drawings.

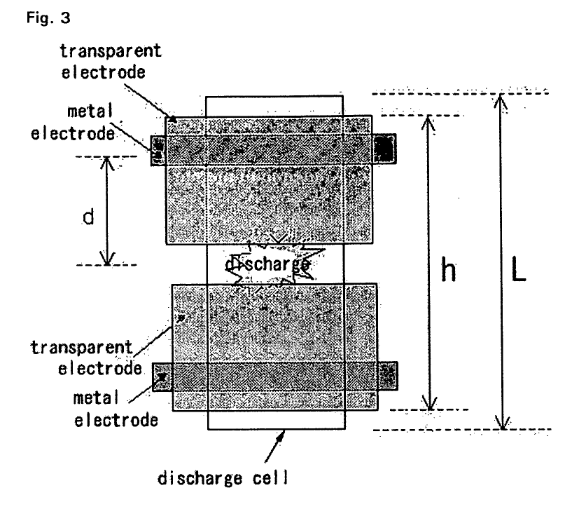

In order to describe the relative location of metal electrodes against transparent electrodes, parameters that can be used in the present context will be defined. FIG. 3 is a plan view showing a front substrate electrode structure of a surface discharge type plasma display panel for explaining a definition of parameters to be used in the present invention.

Hereinafter, a longitudinal width of a discharge cell is defined as “L”. A distance between both ends of two neighboring transparent electrodes is defined as “h”. A distance from the center of a discharge region to the center of the metal electrode is defined as “d”.

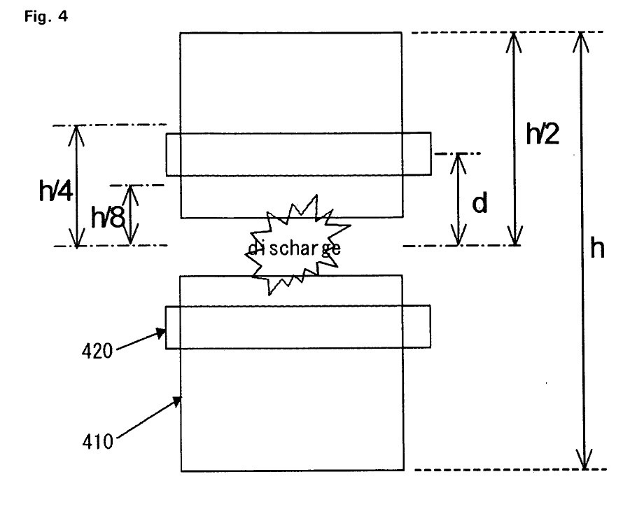

FIG. 4 is a plan view showing a front substrate electrode structure of a surface discharge type plasma display panel according to a first embodiment of the present invention.

As shown in FIG. 4, the PDP according to the first embodiment of the present invention has a surface discharge type PDP structure. In this structure, metal electrodes 420 located on transparent electrodes 410 of a front substrate are located on the outside as much as a distance smaller than h/4 from the center of a cell when viewed from the front.

That is, according to the first embodiment of the present invention, if the center of a discharge region is located at the center of the cell, the distance d from the center of the discharge region to the center of the metal electrodes 420 satisfies the following condition.
d<h/4 Equation 1

In other words, the distance d from the center of the discharge region to the center of the metal electrode 420 should be smaller than h/4, which is the distance from the center of the discharge region.

The metal electrode 420, which is formed at a location proposed in Equation 1, serves to enhance an electric field at the center of the cell where a discharge begins. The enhanced electric field serves to increase brightness, reduce a discharge delay time and lower a discharge start voltage. Therefore, it results in improved efficiency.

FIG. 5 is a graph showing the relationship between an application voltage and efficiency in a conventional PDP and the PDP according to the first embodiment of the present invention. From FIG. 5, it can be seen that the PDP according to the first embodiment of the present invention has efficiency higher 40% to 50% than the conventional PDP.

According to a modification example of the first embodiment of the present invention, the distance d from the center of the discharge region to the center of the metal electrode 420 satisfies the following condition together with the condition of Equation 1.
h/8<d Equation 2

That is, it is required that the distance d from the center of the discharge region to the center of the metal electrode 420 be greater than h/8, which is a distance from the center of the discharge region.

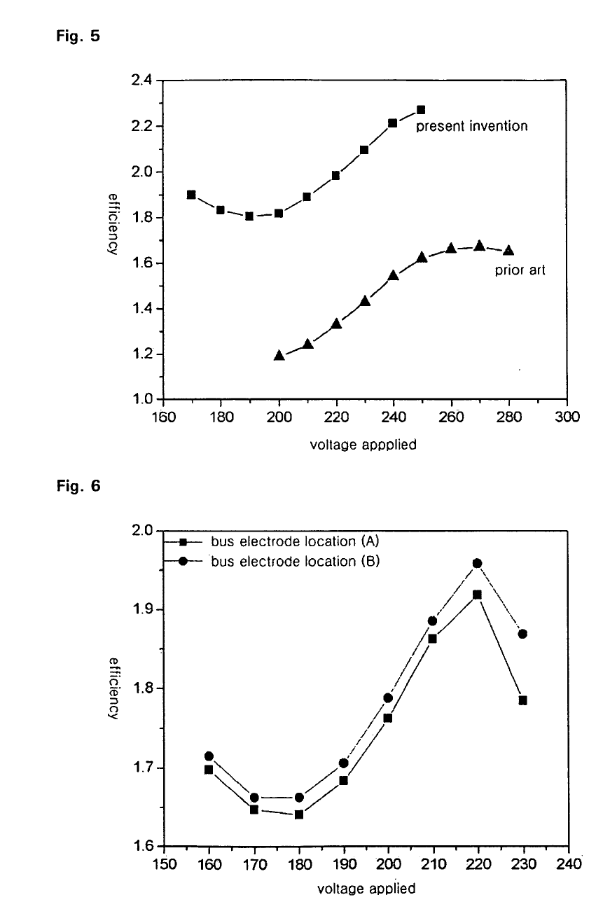

According to the modification example of the first embodiment, it found that h/8<d<h/4 has higher efficiency than d<h/8 since it has a visible ray less shut off by the metal electrode. On the contrary, there is no significant difference in the discharge delay time. FIG. 6 is a graph that efficiency is compared when the location of the metal electrode is d<h/8 (hereinafter, referred to as “(A)”) and when the location of the metal electrode is h/8<d<h/4 (hereinafter, referred to as “(B)”). From FIG. 6, it can be seen that (B) is higher in efficiency than (A).

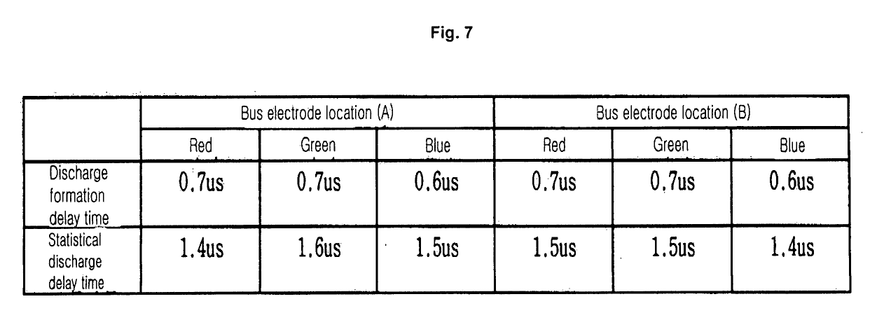

FIG. 7 is a table showing a comparison result of a discharge delay time when the location of the metal electrode is (A) and (B). From FIG. 7, it can be seen that there is almost no difference in the discharge delay time between (A) and (B).

Resultantly, preferably, the distance d from the center of the discharge region to the center of the metal electrode satisfies the following condition.
h/8<d<h/4 Equation 3

Accordingly, if the metal electrodes are located so that it satisfy h/8<d<h/4 being the case (B), brightness, efficiency and discharge stability can be enhanced compared to the prior art.

### Second Embodiment

According to a second embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the metal electrodes are formed at locations inclined toward a side where the pair of the transparent electrodes are opposite to each other, and the plasma display panel further comprises auxiliary metal electrodes formed between the opposite end of the side where the pair of the transparent electrodes are opposite to each other and the metal electrodes.

Further, the metal electrodes are formed between the center of the transparent electrodes in the lateral direction and the side where the pair of the transparent electrodes is opposite to each other.

Moreover, the auxiliary metal electrodes are formed in parallel in two or more columns.

In addition, the auxiliary metal electrodes are formed in zigzags.

The second embodiment of the present invention will now be described in more detail with reference to the accompanying drawings.

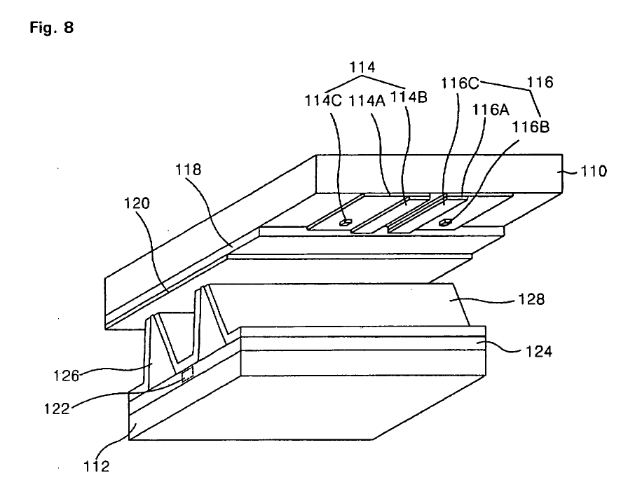

FIG. 8 is a perspective view illustrating the electrode structure of the plasma display panel according to the second embodiment of the present invention.

Referring to FIG. 8, the PDP according to the second embodiment of the present invention includes an upper plate having a pair of sustain electrodes 114 and 116, an upper dielectric layer 118 and a protection film 120 sequentially formed on an upper substrate 110, and a lower plate having an address electrode 122, a lower dielectric layer 124, barrier ribs 126 and a phosphor layer 128 sequentially formed on a lower substrate 112. The upper substrate 110 and the lower substrate 112 are spaced apart from each other in parallel by means of the barrier ribs 126.

The pair of the sustain electrodes 114 and 116 is composed of a scan electrode 114 and a sustain electrode 116. The scan electrode 114 is mainly supplied with a scan signal for a panel scanning and a sustain signal for a discharge sustain. The sustain electrode 116 is mainly supplied with a sustain signal.

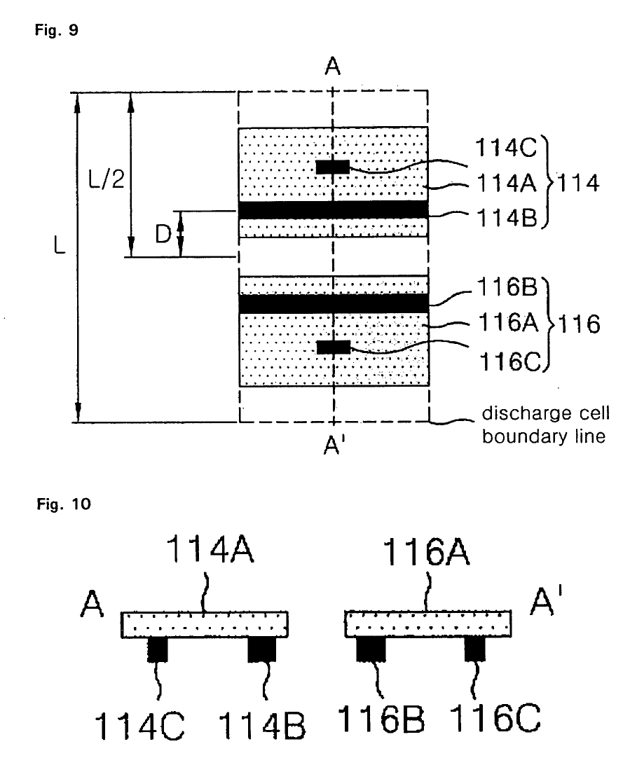

FIG. 9 is a plan view showing the pair of the sustain electrodes shown in FIG. 8. FIG. 10 is a cross-sectional view of the electrode taken along lines A-A′ in FIG. 9.

Referring to FIG. 9 and FIG. 10, the sustain electrode 114 includes a transparent electrode 114A that has a relatively wide width and a stripe shape and that is formed using a transparent electrode material (ITO) in order to transmit a visible ray, and a metal electrode 114B and an auxiliary metal electrode 114C, which have a relatively narrow width and are formed using a metal in order to compensate for a resistant component of the transparent electrode 114A. Meanwhile, the sustain electrode 116 includes a transparent electrode 116A that has a relatively wide width and a stripe shape and that is formed using a transparent electrode material (ITO) in order to transmit a visible ray, and a metal electrode 116B and an auxiliary metal electrode 116C, which have a relatively narrow width and are formed using a metal in order to compensate for a resistant component of the transparent electrode 116A. In the above, the transparent electrodes 114A and 116A of the pair of the sustain electrodes 114 and 116 are opposite to each other with a predetermined gap intervened between them.

The metal electrodes 114B and 116B of the pair of the sustain electrodes 114 and 116 are each formed on the transparent electrodes 114A and 116A between the center of the transparent electrodes 114A and 116A and the center of the discharge cell, respectively, as shown in FIG. 9. That is, the metal electrodes 114B and 116B are formed on the transparent electrodes 114A and 116A, respectively, so that they are each inclined toward a side where the transparent electrodes 114A and 116A are opposite to each other. At this time, assuming that a longitudinal width of the discharge cell is “L” and a distance between the center of the metal electrodes 114B and 116B and the center of the discharge cell is “D”, the location where the metal electrodes 114B and 116B are formed on the transparent electrodes is set to be “D<L/4”. Each of the metal electrodes 114B and 116B serves to enhance an electric field at the central portion of the discharge cell where an electric field begins, thereby shortening a discharge delay time and reducing a discharge start voltage.

Each of the auxiliary metal electrodes 114C and 116C may have a square shape, as shown in FIG. 9. The respective transparent electrodes 114A and 116A are formed between the ends of the auxiliary metal electrodes 114C and 116C on the edge side of the discharge cell and the metal electrodes 114B and 116B. Each of the auxiliary metal electrodes 114C and 116C serves to expand a discharge formed by the metal electrodes 1141B and 116B toward the edge side of the cell.

Therefore, in the PDP according to the second embodiment of the present invention, since the distance between the metal electrodes 114B and 116B is near, a strong electric field is generated at the central portion of the discharge cell upon discharge. Furthermore, a discharge formed by the metal electrodes 114B and 116B is expanded toward the edge side of the discharge cell through the auxiliary metal electrodes 114C and 116C. It is thus possible to lower a discharge start voltage and a discharge sustain voltage and also enhance brightness and efficiency. Moreover, in the PDP according to the second embodiment of the present invention, a discharge delay time is shortened since the discharge start voltage is reduced. Thus, stability of a discharge can be enhanced.

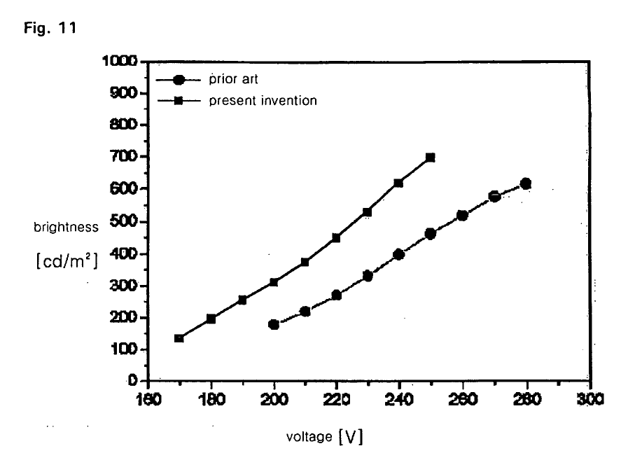

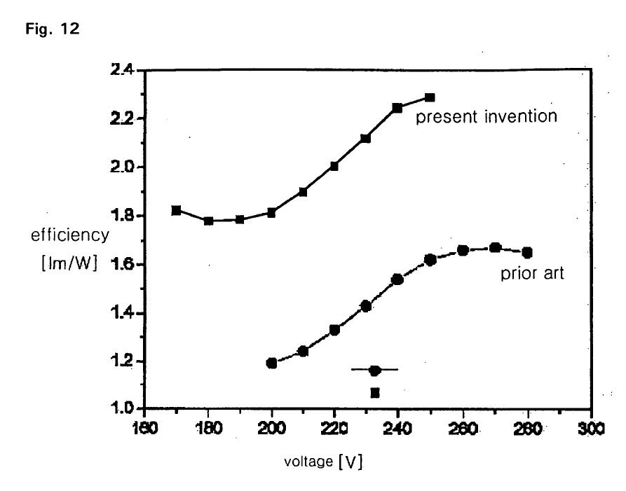

FIG. 11 is a graph showing the relationship between brightness and a voltage in the second embodiment of the present invention and a prior art. FIG. 12 is a graph showing the relationship between efficiency and a discharge voltage in the second embodiment of the present invention and the prior art.

From FIG. 11, it can be seen that brightness of the PDP according to the second embodiment of the present invention is higher about 50% to 70% than the prior art when the discharge voltage is the same. Also, from FIG. 12, it can be seen that efficiency of the PDP according to the second embodiment of the present invention is higher about 40% to 50% than the prior art when the discharge voltage is the same.

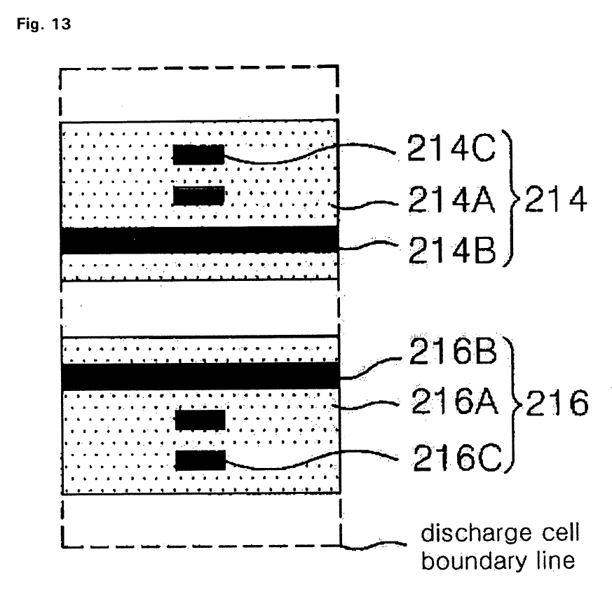

FIG. 13 is a plan view showing a pair of sustain electrodes of a plasma display panel according to a modification example of the second embodiment of the present invention.

The electrode structure of the plasma display panel according to the modification example of the second embodiment of the present invention is the same as the electrode structure of the second embodiment of the present invention shown in FIG. 8 except for the pair of the sustain electrodes shown in FIG. 13. Therefore, only description on FIG. 13 will be given in order to avoid redundancy.

Referring to FIG. 13, a sustain electrode 214 includes a transparent electrode 214A that has a relatively wide width and a stripe shape and that is formed using a transparent electrode material (ITO) in order to transmit a visible ray, and a metal electrode 214B and a number of auxiliary metal electrodes 214C, which have a relatively narrow width and are formed in order to compensate for a resistant component of the transparent electrode 214A. A sustain electrode 216 includes a transparent electrode 216A that has a relatively wide width and a stripe shape and that is formed using a transparent electrode material (ITO) in order to transmit a visible ray, and a metal electrode 216B and a number of auxiliary metal electrodes 216C, which are relatively narrow in width and compensate for a resistant component of the transparent electrode 216A. In the above, the transparent electrodes 214A and 216A of the pair of the sustain electrodes 214 and 216 are opposite to each other with a predetermined gap intervened between them.

The metal electrodes 214B and 216B of the pair of the sustain electrodes 214 and 216 are formed on the transparent electrodes 214A and 216A, respectively, so that they are each inclined toward a side where the transparent electrodes 214A and 216A are opposite to each other. Each of the metal electrodes 214B and 216B serves to enhance an electric field at the central portion of the discharge cell where an electric field begins, thereby shortening a discharge delay time and reducing a discharge start voltage.

Each of the plurality of the auxiliary metal electrodes 214C and 216C has a square shape. The respective auxiliary metal electrodes 214C and 216C are formed each other in parallel between the ends of the transparent electrodes 214A and 216A on the edge side of the discharge cell and the metal electrodes 214B and 216B. The auxiliary metal electrodes 214C and 216C each serve to expand a discharge formed by the metal electrodes 214B and 216B toward the edge side of the cell.

Therefore, in the PDP according to the modification example of the second embodiment of the present invention, upon discharge, a discharge start voltage and a discharge sustain voltage can be reduced and a discharge delay time can be shortened. It is thus possible to improve stability of a discharge. That is, in the PDP according to the modification example of the second embodiment of the present invention, since the distance between the metal electrodes 214B and 216B is near, a strong electric field is generated at the central portion of the discharge cell upon discharge. Furthermore, a discharge formed by the metal electrodes 214B and 216B is expanded toward the edge side of the discharge cell through the plurality of the auxiliary metal electrodes 214C and 216C. It is thus possible to lower a discharge start voltage and a discharge sustain voltage and also enhance brightness and efficiency. Moreover, in the PDP according to the modification example of the second embodiment of the present invention, a discharge delay time is shortened since the discharge start voltage is reduce, enhancing stability of a discharge.

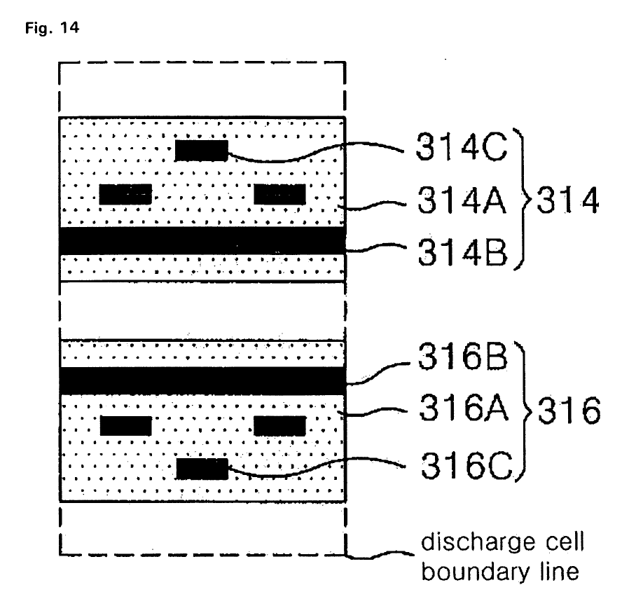

FIG. 14 is a plan view showing a pair of sustain electrodes of a plasma display panel according to another modification example of the second embodiment of the present invention.

The electrode structure of the plasma display panel according to another modification example of the second embodiment of the present invention is the same as the electrode structure of the second embodiment of the present invention shown in FIG. 8 except for the pair of the sustain electrodes shown in FIG. 14. Therefore, only description on FIG. 14 will be given in order to avoid redundancy.

Referring to FIG. 14, a sustain electrode 314 includes a transparent electrode 314A that has a relatively wide width and a stripe shape and that is formed using a transparent electrode material (ITO) in order to transmit a visible ray, a metal electrode 314B that is relatively narrow in width and compensates for a resistant component of the transparent electrode 314A, and a number of auxiliary metal electrodes 314C arranged in zigzags. Meanwhile, a sustain electrode 316 includes a transparent electrode 316A that has a relatively wide width and a stripe shape and that is formed using a transparent electrode material (ITO) in order to transmit a visible ray, a metal electrode 316B that is relatively narrow in width and compensates for a resistant component of the transparent electrode 316A, and a number of auxiliary metal electrodes 316C arranged in zigzags. In the above, the transparent electrodes 314A and 316A of the pair of the sustain electrodes 314 and 316 are opposite to each other with a predetermined gap intervened between them.

The metal electrodes 314B and 316B of the sustain electrodes 314 and 316 are formed on the transparent electrodes 314A and 316A, respectively, so that they are each inclined toward a side where the transparent electrodes 314A and 316A are opposite to each other. Each of the metal electrodes 314B and 316B serves to enhance an electric field at the central portion of the discharge cell where an electric field begins, thereby shortening a discharge delay time and reducing a discharge start voltage.

Each of the plurality of the auxiliary metal electrodes 314C and 316C is a square shape. The auxiliary metal electrodes 314C and 316C are formed in zigzags between the ends of the transparent electrodes 314A and 316A on the edge side of the discharge cell and the metal electrodes 314B and 316B. The auxiliary metal electrodes 314C and 316C each serve to expand a discharge formed by the metal electrodes 314B and 316B toward the edge side of the discharge cell.

Therefore, in the PDP according to another modification example of the second embodiment of the present invention, upon discharge, a discharge start voltage and a discharge sustain voltage can be reduced and a discharge delay time can be reduced. It is thus possible to improve stability of a discharge. That is, in the PDP according to another modification example of the second embodiment of the present invention, since the distance between the metal electrodes 314B and 316B is near, a strong electric field is generated at the central portion of the discharge cell upon discharge. Furthermore, a discharge formed by the metal electrodes 314B and 316B is expanded toward the edge side of the discharge cell through the plurality of the auxiliary metal electrodes 314C and 316C. It is thus possible to lower a discharge start voltage and a discharge sustain voltage and also enhance brightness and efficiency. Moreover, in the PDP according to another modification example of the second embodiment of the present invention, a discharge delay time is shortened since the discharge start voltage is reduced. Stability of a discharge can be thus enhanced.

### Third Embodiment

According to a third embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the metal electrodes are formed at locations inclined toward a side where the pair of the transparent electrodes are opposite to each other, and the plasma display panel further comprises projection electrodes projected from the metal electrodes.

In the above, the metal electrodes are formed between the center of the transparent electrodes in the lateral direction and the side where the pair of the transparent electrodes is opposite to each other.

Furthermore, the projection electrodes are projected from the middle of the metal electrodes.

Also, the plasma display panel further includes auxiliary metal electrodes that are formed in parallel to the metal electrodes at the ends of the projection electrodes.

In addition, the length of the auxiliary metal electrodes is shorter than that of the metal electrodes.

Moreover, the plasma display panel further includes auxiliary metal electrodes that intersect the middle portion of the projection electrodes and are formed in parallel to the metal electrodes.

In the above, the length of the auxiliary metal electrodes is shorter than that of the metal electrodes.

Further, the plasma display panel further includes first auxiliary metal electrodes that are formed in parallel to the metal electrodes at the ends of the projection electrodes, and second auxiliary metal electrodes that intersect the middle portion of the projection electrodes between the first auxiliary metal electrode and the metal electrodes and are formed in parallel to the metal electrodes.

Also, the length of the first and second auxiliary metal electrodes is shorter than that of the metal electrodes.

The third embodiment of the present invention will now be described in more detail with reference to the accompanying drawings.

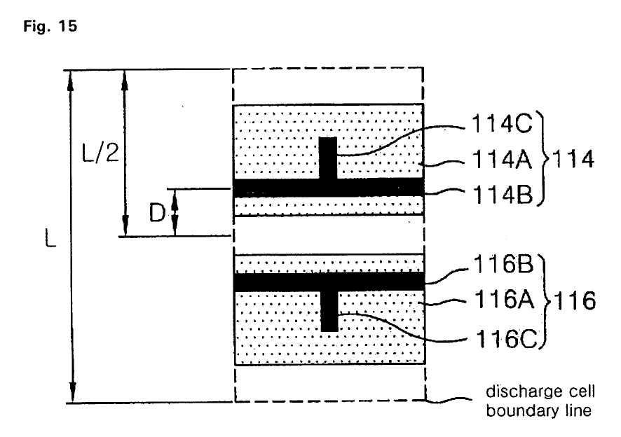

FIG. 15 is a plan view showing a pair of sustain electrodes of a plasma display panel according to the third embodiment of the present invention.

The electrode structure of the plasma display panel according to the third embodiment of the present invention is the same as the electrode structure of the second embodiment of the present invention shown in FIG. 8 except for the pair of the sustain electrodes shown in FIG. 15. Therefore, only description on FIG. 15 will be given in order to avoid redundancy.

Referring to FIG. 15, a sustain electrode 114 includes a transparent electrode 114A that has a relatively wide width and a stripe shape and that is formed using a transparent electrode material (ITO) in order to transmit a visible ray, and a metal electrode 114B and a projection metal electrode 114C, which have a relatively narrow width and are formed using a metal in order to compensate for a resistant component of the transparent electrode 114A. Meanwhile, a sustain electrode 116 includes a transparent electrode 116A that has a relatively wide width and a stripe shape and that is formed using a transparent electrode material (ITO) in order to transmit a visible ray, and a metal electrode 116B and a projection metal electrode 116C, which have a relatively narrow width and are formed using a metal in order to compensate for a resistant component of the transparent electrode 116A. In the above, the transparent electrodes 114A and 116A of the pair of the sustain electrodes 114 and 116 are opposite to each other with a predetermined gap intervened between them.

Land 116B of the pair of the sustain electrodes 114 and 116 are formed on the transparent electrodes 114A and 116A between the center of the transparent electrodes 114A and 116A and the center of the discharge cell, respectively. That is, the metal electrodes 114B and 116B are formed on the transparent electrodes 114A and 116A, respectively, so that they are each inclined toward a side where the transparent electrodes 114A and 116A are opposite to each other. At this time, assuming that a longitudinal width of the discharge cell is “L” and a distance between the center of the metal electrodes 114B and 116B and the center of the discharge cell is “D”, the location where the metal electrodes 114B and 116B are formed is set to be “D<L/4” in the discharge cell. Each of the metal electrodes 114B and 116B serves to enhance an electric field at the central portion of the discharge cell where an electric field begins, thereby shortening a discharge delay time and reducing a discharge start voltage.

The projection metal electrodes 114C and 116C are each protruded from the middle of the metal electrodes 114B and 116B to the edge side of the discharge cell and are thus formed on the transparent electrodes 114A and 116A. Thereby, the metal electrodes 114B and 116B and the projection metal electrodes 114C and 116C are formed on the transparent electrodes 114A and 116A, respectively, so that they have a T shape. The projection metal electrodes 114C and 116C each serve to expand a discharge formed by the metal electrodes 114B and 116B toward the edge side of the discharge cell.

Therefore, in the PDP according to the third embodiment of the present invention, since the distance between the metal electrodes 114B and 116B is near, a strong electric field is generated at the central portion of the discharge cell upon discharge. Furthermore, the discharge formed by the metal electrodes 114B and 116B is expanded toward the edge side of the discharge cell through the projection metal electrodes 114C and 116C. It is thus possible to lower a discharge start voltage and a discharge sustain voltage and also enhance brightness and efficiency. Moreover, in the PDP according to the third embodiment of the present invention, a discharge delay time is shortened since the discharge start voltage is reduced. Stability of a discharge can be thus enhanced.

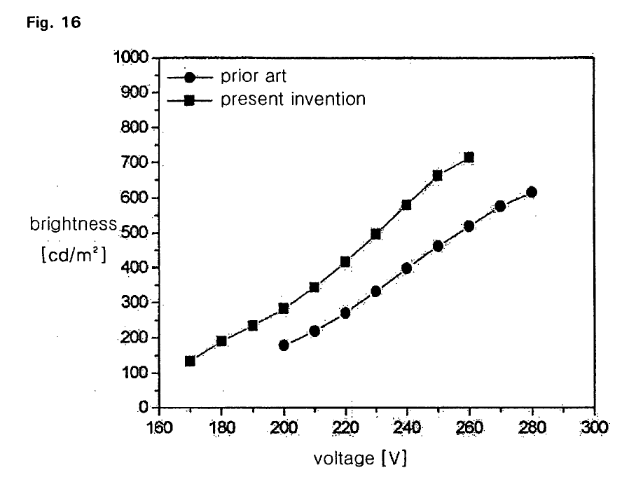

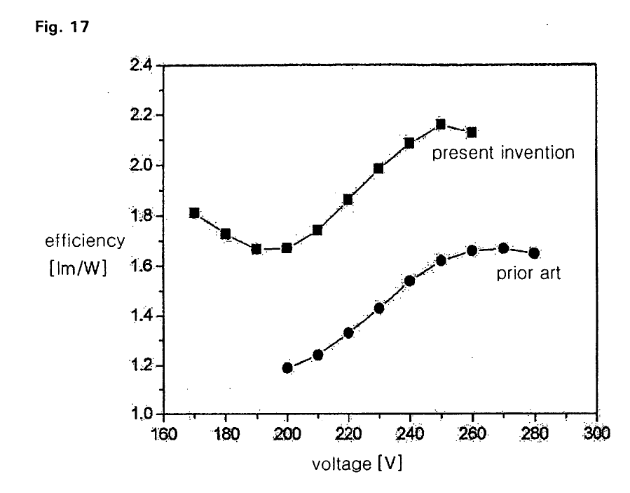

FIG. 16 is a graph showing the relationship between brightness and a discharge voltage in the third embodiment of the present invention and a prior art. FIG. 17 is a graph showing the relationship between efficiency and a discharge voltage in the third embodiment of the present invention and a prior art.

From FIG. 16, it can be seen that brightness of the PDP according to the third embodiment of the present invention is higher about 40% to 50% than the prior art when the discharge voltage is the same. Moreover, from FIG. 17, it can be seen that efficiency of the PDP according to the third embodiment of the present invention is higher about 30% to 40% than the prior art when the discharge voltage is the same.

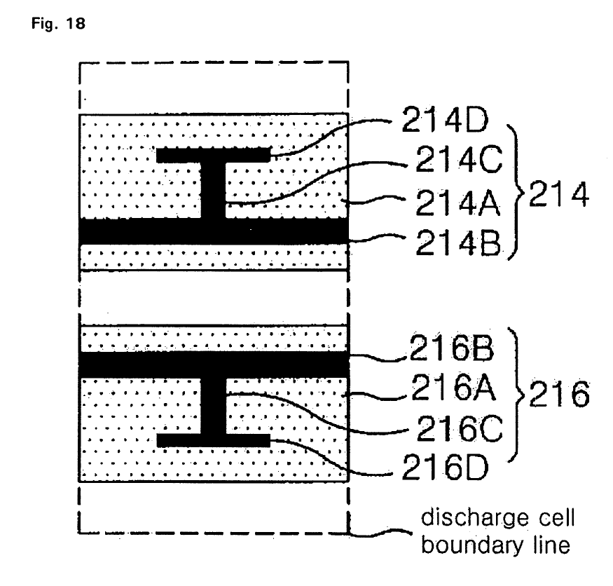

FIG. 18 is a plan view showing a pair of sustain electrodes of a plasma display panel according to a modification example of the third embodiment of the present invention.

The electrode structure of the plasma display panel according to the modification example of the third embodiment of the present invention is the same as the electrode structure of the second embodiment of the present invention shown in FIG. 8 except for the pair of the sustain electrodes shown in FIG. 18. Therefore, only description on FIG. 18 will be given in order to avoid redundancy.

Referring to FIG. 18, a sustain electrode 214 includes a transparent electrode 214A that has a relatively wide width and a stripe shape and that is formed using a transparent electrode material (ITO) in order to transmit a visible ray, and a metal electrode 214B, a projection metal electrode 214C and an auxiliary metal electrode 214D, which are relatively narrow in width and compensate for a resistant component of the transparent electrode 214A. Meanwhile, a sustain electrode 216 includes a transparent electrode 216A that has a relatively wide width and a stripe shape and that is formed using a transparent electrode material (ITO) in order to transmit a visible ray, and a metal electrode 216B, a projection metal electrode 216C and an auxiliary metal electrode 216D, which are relatively narrow in width and compensate for a resistant component of the transparent electrode 216A. In the above, the transparent electrodes 214A and 216A of the pair of the sustain electrodes 214 and 216 are opposite to each other with a predetermined gap intervened between them.

The metal electrodes 214B and 216B of the pair of the sustain electrodes 214 and 216 are formed on the transparent electrodes 214A and 216A, respectively, so that they are each inclined toward a side where the transparent electrodes 214A and 216A are opposite to each other. Each of the metal electrodes 214B and 216B serves to enhance an electric field at the central portion of the discharge cell where an electric field begins, thereby shortening a discharge delay time and reducing a discharge start voltage.

The projection metal electrodes 214C and 216C are each protruded from the middle of the metal electrodes 214B and 216B to the edge side of the discharge cell and are thus formed on the transparent electrodes 214A and 216A, respectively. Thereby, the metal electrodes 214B and 216B and the projection metal electrodes 214C and 216C are formed on the transparent electrodes 214A and 216A, respectively, so that they have a T shape. The projection metal electrodes 214C and 216C each serve to expand a discharge formed by the metal electrodes 214B and 216B toward the edge side of the cell.

The auxiliary metal electrodes 214D and 216D are each formed in parallel to the metal electrodes 214B and 216B at the ends of the projection metal electrodes 214C and 216C. The length of each of the auxiliary metal electrodes 214D and 216D is shorter than that of each of the metal electrodes 214B and 216B. Thereby, the metal electrodes 214B and 216B, the projection metal electrodes 214C and 216C, and the auxiliary metal electrodes 214D and 216D are formed on the transparent electrodes 214A and 216A, respectively, so that they have an H shape. These auxiliary metal electrodes 214D and 216D each serve to expand a discharge formed by the metal electrodes 214B and 216B to the edge sides of the cell.

Therefore, in the PDP according to the modification example of the third embodiment of the present invention, upon discharge, a discharge start voltage and a discharge sustain voltage can be reduced and a discharge delay time can be also reduced. It is thus possible to improve stability of a discharge. That is, in the PDP according to the modification example of the third embodiment of the present invention, since the distance between the metal electrodes 214B and 216B is near, a strong electric field is generated at the central portion of the discharge cell upon discharge. Furthermore, a discharge formed by the metal electrodes 214B and 216B is expanded toward the edge sides of the discharge cell through the projection metal electrodes 214C and 216C and the auxiliary metal electrodes 214D and 216D. It is thus possible to lower a discharge start voltage and a discharge sustain voltage and also enhance brightness and efficiency. In addition, in the PDP according to the modification example of the third embodiment of the present invention, the discharge delay time is shortened since the discharge start voltage is reduced. Stability of a discharge can be thus enhanced.

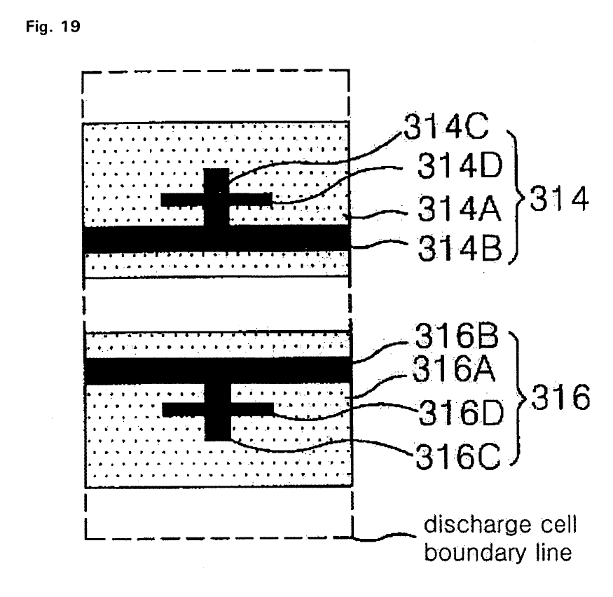

FIG. 19 is a plan view showing a pair of sustain electrodes of a plasma display panel according to another modification example of the third embodiment of the present invention.

The electrode structure of the plasma display panel according to another modification example of the third embodiment of the present invention is the same as the electrode structure of the second embodiment of the present invention shown in FIG. 8 except for the pair of the sustain electrodes shown in FIG. 19. Therefore, only description on FIG. 19 will be given in order to avoid redundancy.

Referring to FIG. 19, a sustain electrode 314 includes a transparent electrode 314A that has a relatively wide width and a stripe shape and that is formed using a transparent electrode material (ITO) in order to transmit a visible ray, and a metal electrode 314B, a projection metal electrode 314C and an auxiliary metal electrode 314D, which are relatively narrow in width and compensate for a resistant component of the transparent electrode 314A. Meanwhile, a sustain electrode 316 includes a transparent electrode 316A h that has a relatively wide width and a stripe shape and that is formed using a transparent electrode material (ITO) in order to transmit a visible ray, and a metal electrode 316B, a projection metal electrode 316C and an auxiliary metal electrode 316D, which are relatively narrow in width and compensate for a resistant component of the transparent electrode 316A. In the above, the transparent electrodes 314A and 316A of the pair of the sustain electrodes 314 and 316 are opposite to each other with a predetermined gap intervened between them.

The metal electrodes 314B and 316B of the pair of the sustain electrodes 314 and 316 are formed on the transparent electrodes 314A and 316A, respectively, so that they are each inclined toward a side where the transparent electrodes 314A and 316A are opposite to each other. Each of these metal electrodes 314B and 316B serves to enhance an electric field at the central portion of the discharge cell where an electric field begins, thereby shortening a discharge delay time and reducing a discharge start voltage.

The projection metal electrodes 314C and 316C are each protruded from the middle of the metal electrodes 314B and 316B to the edge side of the discharge cell and are thus formed on the transparent electrodes 314A and 316A, respectively. Thereby, the metal electrodes 314B and 316B and the projection metal electrodes 314C and 316C are formed on the transparent electrodes 314A and 316A, respectively, so that they have a T shape. The projection metal electrodes 314C and 316C each serve to expand a discharge formed by the metal electrodes 314B and 316B toward the edge side of the cell.

The auxiliary metal electrodes 314D and 316D are each formed in parallel to the metal electrodes 314B and 316B in the middle of the projection metal electrodes 314C and 316C. The length of each of the auxiliary metal electrodes 314D and 316D is shorter than that of each of the metal electrodes 314B and 316B. Thereby, the projection metal electrodes 314C and 316C and the auxiliary metal electrodes 314D and 316D are formed on the transparent electrodes 314A and 316A, respectively, so that they have a + shape. These auxiliary metal electrodes 314D and 316D each serve to expand a discharge formed by the metal electrodes 314B and 316B to the edge sides of the cell.

Therefore, in the PDP according to another modification example of the third embodiment of the present invention, upon discharge, a discharge start voltage and a discharge sustain voltage can be reduced and a discharge delay time can be also reduced. It is thus possible to improve stability of a discharge. That is, in the PDP according to another modification example of the third embodiment of the present invention, since the distance between the metal electrodes 314B and 316B is near, a strong electric field is generated at the central portion of the discharge cell upon discharge. Furthermore, a discharge formed by the metal electrodes 314B and 316B is expanded toward the edge side of the discharge cell through the projection metal electrodes 314C and 316C and the auxiliary metal electrodes 314D and 316D. It is thus possible to lower a discharge start voltage and a discharge sustain voltage and also enhance brightness and efficiency. In addition, in the PDP according to another modification example of the third embodiment of the present invention, a discharge delay time is shortened since the discharge start voltage is reduced. Stability of a discharge can be thus enhanced.

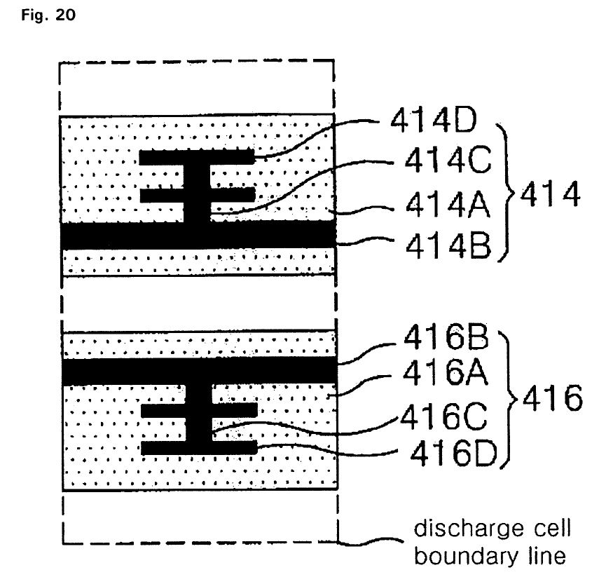

FIG. 20 is a plan view showing a pair of sustain electrodes of a plasma display panel according to still another modification example of the third embodiment of the present invention.

The electrode structure of the plasma display panel according to still another modification example of the third embodiment of the present invention is the same as the electrode structure of the second embodiment of the present invention shown in FIG. 8 except for the pair of the sustain electrodes shown in FIG. 20. Therefore, only description on FIG. 20 will be given in order to avoid redundancy.

Referring to FIG. 20, a sustain electrode 414 includes a transparent electrode 414A that has a relatively wide width and a stripe shape and that is formed using a transparent electrode material (ITO) in order to transmit a visible ray, and a metal electrode 414B, a projection metal electrode 414C and an auxiliary metal electrode 414D, which are relatively narrow in width and compensate for a resistant component of the transparent electrode 414A. Further, a sustain electrode 416 includes a transparent electrode 416A that has a relatively wide width and a stripe shape and that is formed using a transparent electrode material (ITO) in order to transmit a visible ray, and a metal electrode 416B, a projection metal electrode 416C and an auxiliary metal electrode 416D, which are relatively narrow in width and compensate for a resistant component of the transparent electrode 416A. In the above, the transparent electrodes 414A and 416A of the pair of the sustain electrodes 414 and 416 are opposite to each other with a predetermined gap intervened between them.

The metal electrodes 414B and 416B of the pair of the sustain electrodes 414 and 416 are formed on the transparent electrodes 414A and 416A, respectively, so that they are each inclined toward a side where the transparent electrodes 414A and 416A are opposite to each other. Each of these metal electrodes 414B and 416B serves to enhance an electric field at the central portion of the discharge cell where an electric field begins, thereby shortening a discharge delay time and reducing a discharge start voltage.

The projection metal electrodes 414C and 416C are protruded from the middle of the metal electrodes 414B and 416B to the edge side of the discharge cell and are thus formed on the transparent electrodes 414A and 416A. Thereby, the metal electrodes 414B and 416B and the projection metal electrodes 414C and 416C are formed on the transparent electrodes 414A and 416A, respectively, so that they have a T shape. The projection metal electrodes 414C and 416C each serve to expand a discharge formed by the metal electrodes 414B and 416B toward the edge side of the cell.

The auxiliary metal electrode 414D has a first auxiliary metal electrode that is formed in parallel to the metal electrode 414B in the middle of the projection metal electrode 414C and is shorter in length than the metal electrode 414A, and a second auxiliary metal electrode that is formed in parallel to the metal electrode 414B at the end of the projection metal electrode 414C and is shorter in length then the metal electrode 414A. Meanwhile, the auxiliary metal electrode 416D has a first auxiliary metal electrode that is formed in parallel to the metal electrode 416B in the middle of the projection metal electrode 416C and is shorter in length than the metal electrode 416A, and a second auxiliary metal electrode that is formed in parallel to the metal electrode 416B at the end of the projection metal electrode 416C and is shorter in length than the metal electrode 416A. In the above, the first and second auxiliary metal electrodes intersect the projection metal electrode 414C and 416C in a “=” shape. Thereby, the projection metal electrodes 414C and 416C and the auxiliary metal electrodes 414D and 416D are formed on the transparent electrodes 414A and 416A, respectively, so that they have a ± shape. These auxiliary metal electrodes 414D and 416D each serve to expand a discharge formed by the metal electrodes 414B and 416B to the edge side of the cell.

Therefore, in the PDP according to still another modification example of the third embodiment of the present invention, upon discharge, a discharge start voltage and a discharge sustain voltage can be reduced and a discharge delay time can be reduced. It is thus possible to improve stability of a discharge. That is, in the PDP according to still another modification example of the third embodiment of the present invention, since the distance between the metal electrodes 414B and 416B is near, a strong electric field is generated at the central portion of the discharge cell upon discharge. Furthermore, a discharge formed by the metal electrodes 414B and 416B is expanded toward the edge side of the discharge cell through the projection metal electrodes 414C and 416C and the auxiliary metal electrodes 414D and 416D. It is thus possible to lower a discharge start voltage and a discharge sustain voltage and also enhance brightness and efficiency. Moreover, in the PDP according to still another modification example of the third embodiment of the present invention, a discharge delay time is shortened since the discharge start voltage is reduced. Thus, stability of a discharge can be enhanced.

### Fourth Embodiment

According to a fourth embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the transparent electrodes are included in the discharge cell, and assuming that a distance from the center of a discharge region between the pair of the transparent electrodes to the center of the metal electrodes is “d” and a longitudinal width of the discharge cell is “L”, a location on the transparent electrodes of the metal electrodes satisfies d<L/4.

Also, the transparent electrodes include projections that are projected from the center of the discharge cell to the outer block of the discharge cell.

Further, the projections have a shape.

In addition, auxiliary metal electrodes are formed at the ends of the projections.

Moreover, auxiliary metal electrodes are formed at both ends of the projections.

The fourth embodiment of the present invention will now be described in more detail with reference to the accompanying drawings.

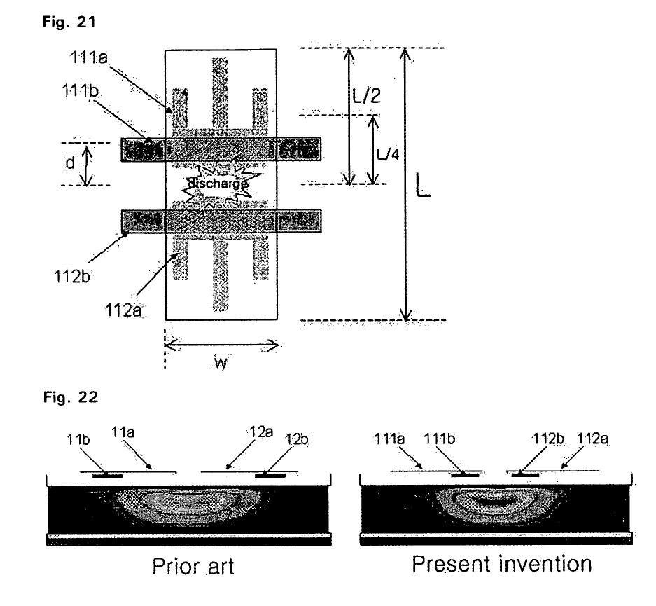

FIG. 21 is a plan view showing a front substrate electrode structure of a PDP according to the fourth embodiment of the present invention.

The electrode structure of the plasma display panel according to the fourth embodiment of the present invention is the same as that of the second embodiment of the present invention shown in FIG. 8 except for the front substrate electrode structure shown in FIG. 21. Only description on FIG. 21 will be given in order to avoid redundancy.

Referring to FIG. 21, in electrodes formed on the front substrate of the PDP according to the fourth embodiment of the present invention, assuming that a longitudinal width of a discharge cell that is demarcated by barrier ribs (not shown) is L and a lateral width of the discharge cell is w, metal electrodes 111b and 112b among the electrodes formed on the front substrate are formed within a point, which is L/4 from the center of the discharge cell (d<L/4). Transparent electrodes 111a and 112a among the electrodes formed on the front substrate are formed within the discharge cell. As such, the metal electrodes 111b and 112b disposed at the central portion of the discharge cell serve to enhance an electric field at the center of the cell when the PDP is driven, compared to a case where the metal electrodes 111b and 112b are disposed at the outer block of the cell. A discharge start voltage and a discharge sustain voltage are thus reduced.

Meanwhile, as described above, the metal electrode 111b and 112b that are disposed substantially at the central portion of the cell are formed using an opaque metal material, thereby lowering transmittance upon discharge. Thus, this may become a factor to lower brightness. Accordingly, in order to increase overall brightness by transferring a discharge generated at the center of the cell to the outer block of the cell effectively, it is required that the structure of the transparent electrodes 111a and 112a include projections projected from the center of the discharge cell to the outer block of the discharge cell. It is preferred that the projections of the transparent electrode have a shape.

FIG. 22 shows a comparison result of the electron density in the front substrate electrode structure of the PDP according to the fourth embodiment of the present invention and a prior art. Referring to FIG. 22, in the electrode structure of the PDP according to the fourth embodiment of the present invention, it can be seen that the electron density is further increased in a discharge cell region and an electric field is thus further enhanced when the PDP is driven, compared to the prior art.

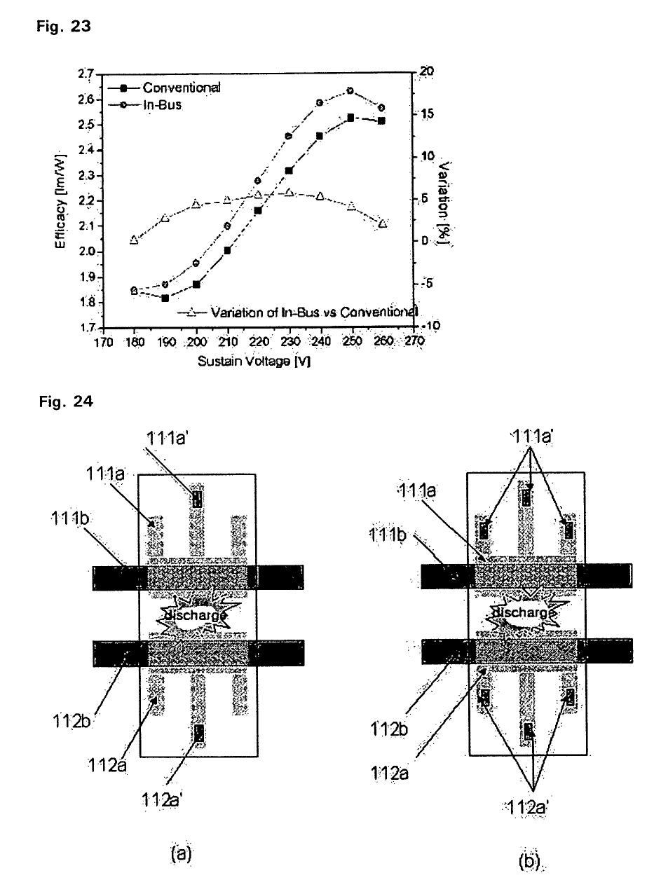

FIG. 23 is a graph showing the relationship between luminous efficiency and a sustain voltage in the electrode structure of the PDP according to the fourth embodiment of the present invention and the electrode structure of a conventional PDP. Referring to FIG. 23, a conventional graph refers to a conventional PDP electrode structure and shows luminous efficiency when a bus electrode is located at the outer block of a discharge cell. An in-bus graph refers to the electrode structure of the PDP according to the fourth embodiment of the present invention and shows luminous efficiency when a bus electrode is located at the central portion of a discharge cell. From FIG. 23, it can be seen that luminous efficiency of the electrode structure of the PDP according to the fourth embodiment of the present invention is higher about 5% than the electrode structure of the conventional PDP.

FIG. 24 is a plan view showing a front substrate electrode structure of a PDP according to a modification example of the fourth embodiment of the present invention. Auxiliary metal electrodes 111a′ and 112a′ are formed at the ends of the longest projection among transparent electrodes 111a and 112a having a shape from the center of a discharge cell to the outer block of the discharge cell, as shown in FIG. 24(a), or the auxiliary metal electrodes 111a′ and 112a′ are formed at all the ends of the projections among the transparent electrodes 111a and 112a, as shown in FIG. 24(b). As such, the auxiliary metal electrodes 111a′ and 112a′ formed at the ends of the projections of the transparent electrodes cause a strong electric field to occur at a location where the auxiliary metal electrodes are formed when the PDP is driven. It is thus possible to lower a discharge start voltage. It is possible to improve brightness characteristics due to expansion of a discharge region.

### Fifth Embodiment

According to a fifth embodiment of the present invention, there is provided a plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell, wherein the transparent electrodes are formed by patterning, and assuming that a distance from the center of a discharge region between the pair of the transparent electrodes to the center of the metal electrodes is “d” and a longitudinal width of the discharge cell is “L”, a location on the transparent electrodes of the metal electrodes satisfies d<L/4.

Furthermore, the transparent electrodes include a first transparent electrode and a second transparent electrode, the first transparent electrode is formed along the inside of the barrier ribs surrounding the discharge cell, and the second transparent electrode is connected between the metal electrode and the first transparent electrode.

Moreover, the first transparent electrode is bent along the inside of the barrier ribs.

Also, auxiliary metal electrodes are formed at predetermined locations of the transparent electrode.

In addition, auxiliary metal electrodes are formed at predetermined locations of the first or second transparent electrode.

The fifth embodiment of the present invention will now be described in detail with reference to the accompanying drawings.

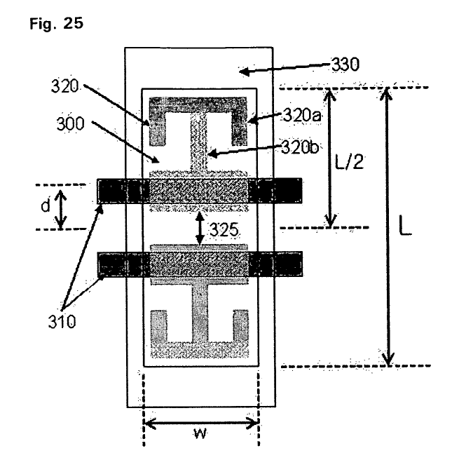

FIG. 25 is a plan view showing a front substrate electrode structure of a plasma display panel according to the fifth embodiment of the present invention. Referring to FIG. 25, metal electrodes 310 of the plasma display panel according to the present invention are located at the center of a discharge cell 300. That is, assuming that a distance from the center of one of the metal electrodes 310 to the center of a discharge gap 325 is d and a longitudinal width of the discharge cell 300 is L, the metal electrode 310 is located at the central portion of the discharge cell 300 so that d is smaller than L/4.

Furthermore, the plasma display panel according to the present invention includes first transparent electrodes 320a and second transparent electrodes 320b. The first transparent electrodes 320a and the second transparent electrodes 320b are formed by patterning.

In the above, the first transparent electrodes 320a are bent along barrier ribs 330, so that light is emitted from a phosphor layer formed on the barrier rib 330. The second transparent electrodes 320b are connected between the metal electrode 310 and the first transparent electrode 320a, diffusing a discharge over the entire discharge cell 300.

Since the first transparent electrodes 320a and the second transparent electrodes 320b are formed by patterning as such, the area of the transparent electrodes is reduced. This results in reduction in the amount of current.

Since the metal electrode 310 is located at the center of the cell as such, a discharge start voltage and a discharge sustain voltage are reduced. Further, since a discharge is diffused evenly all over the discharge cell 330 including the vicinity of the barrier rib 300 by means of the first transparent electrodes 320a and the second transparent electrode 320bs, a phosphor material can be used efficiently. It is thus possible to solve various problems due to increase in the xenon content.

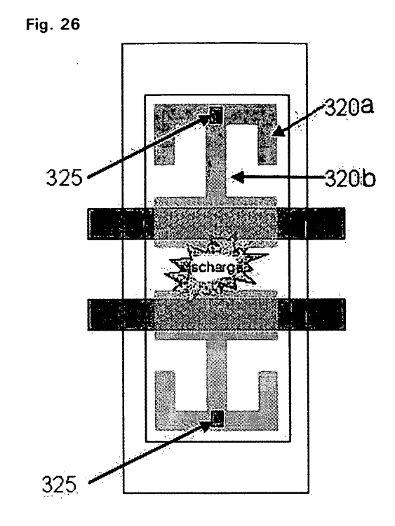

FIGS. 26 and 27 are plan views showing a front substrate electrode structure of a plasma display panel according to a modification example of the fifth embodiment of the present invention. As shown in FIGS. 26 and 27, in the modification example of the fifth embodiment of the present invention, auxiliary metal electrodes 325 are formed at predetermined locations of at least one of first transparent electrodes 320a and second transparent electrodes 320b. Accordingly, a discharge is performed more smoothly.

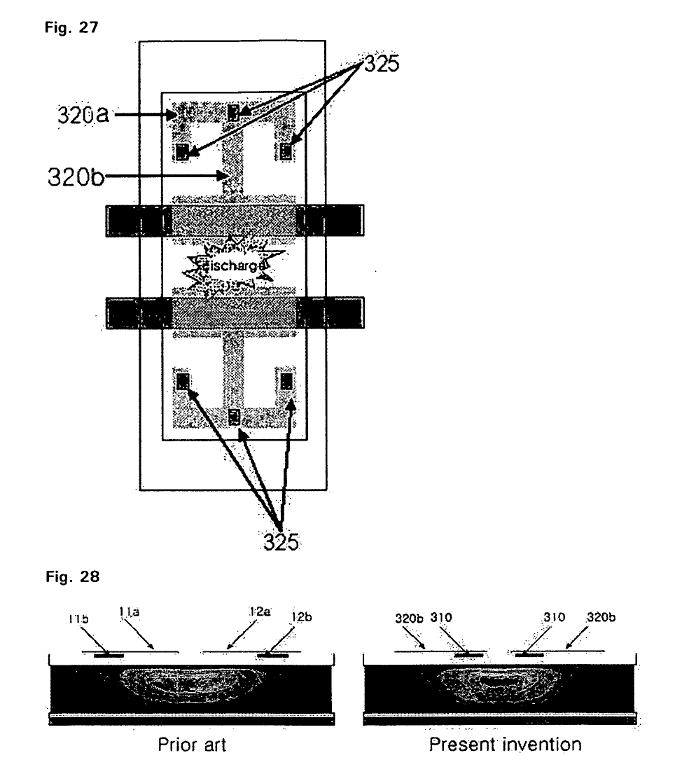

FIG. 28 shows a comparison result of the electron density in the electrode structure according to the fifth embodiment of the present invention and a common electrode structure. From FIG. 28, it can be seen that the electron density according to the electrode structure of the present invention is further higher than that of the common electrode structure in a discharge cell region and an electric field is thus further enhanced when the plasma display panel is driven.

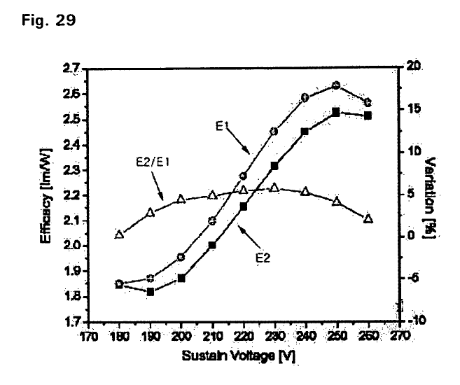

FIG. 29 is a graph showing a comparison result of luminous efficiency E1 of the plasma display panel having the electrode structure according to the fifth embodiment of the present invention and luminous efficiency E2 of the plasma display panel having the common electrode structure when a sustain voltage varies. From FIG. 29, it can be seen that luminous efficiency of the plasma display panel having the electrode structure according to the fifth embodiment of the present invention is higher about 5% than that of the plasma display panel having the common electrode structure.

As described above, according to a plasma display panel of the present invention, brightness and efficiency can be increased without increasing the Xe content. Furthermore, it is possible to reduce power consumption since a discharge start voltage and a discharge sustain voltage are reduced. Discharge stability can be improved since a discharge delay time is shortened.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel having a front substrate and a rear substrate opposite to each other, the plasma display panel including a pair of transparent electrodes formed on the opposite surface of the front substrate, metal electrodes each formed on the transparent electrodes, a dielectric layer that covers the transparent electrodes and the metal electrodes, a protection film coated on the dielectric layer, address electrodes formed on the opposite surface of the rear substrate, a dielectric layer that covers the address electrodes, barrier ribs formed on the dielectric layer, a discharge cell demarcated by the barrier ribs, and a phosphor layer coated on the inside of the discharge cell,
wherein the metal electrodes are formed at locations inclined toward a side where the pair of the transparent electrodes are opposite to each other, and
the plasma display panel further comprises projection electrodes projected from the metal electrodes.

2. The plasma display panel as claimed in claim 1, wherein the metal electrodes are formed between the center of the transparent electrodes in the lateral direction and the side where the pair of the transparent electrodes is opposite to each other.

3. The plasma display panel as claimed in claim 1, wherein the projection electrodes are projected from the middle of the metal electrodes.

4. The plasma display panel as claimed in claim 1, further comprising auxiliary metal electrodes that are formed in parallel to the metal electrodes at the ends of the projection electrodes.

5. The plasma display panel as claimed in claim 4, wherein the length of the auxiliary metal electrodes is shorter than that of the metal electrodes.

6. The plasma display panel as claimed in claim 1, further comprising auxiliary metal electrodes that intersect the middle portion of the projection electrodes and are formed in parallel to the metal electrodes.

7. The plasma display panel as claimed in claim 6, wherein the length of the auxiliary metal electrodes is shorter than that of the metal electrodes.

8. The plasma display panel as claimed in claim 1, further comprising: first auxiliary metal electrodes that are formed in parallel to the metal electrodes at the ends of the projection electrodes; and second auxiliary metal electrodes that intersect the middle portion of the projection electrodes between the first auxiliary metal electrode and the metal electrodes and are formed in parallel to the metal electrodes.

9. The plasma display panel as claimed in claim 8, wherein the length of the first and second auxiliary metal electrodes is shorter than that of the metal electrodes.
